(19) United States
(12) Patent Application Publication
(10) Pub. No.: US 2024/0182813 A1
(43) Pub. Date: Jun. 6, 2024

(54) PROCESS FOR MAKING A MAGNESIUM LINEAR ALKYL BENZENE SULPHONATE ANIONIC DETERSIVE SURFACTANT FLAKE

(71) Applicant: The Procter & Gamble Company, Cincinnati, OH (US)

(72) Inventors: Olgun BESIRIK, Newcastle upon Tyne (GB); Jason Allen STAMPER, Covington, KY (US); Hossam Hassan TANTAWY, Morpeth (GB)

(21) Appl. No.: 18/475,345

(22) Filed: Sep. 27, 2023

Related U.S. Application Data
(60) Provisional application No. 63/430,378, filed on Dec. 6, 2022.

(51) Int. Cl. C11D 1/22; C11D 11/00; C11D 17/06

(52) U.S. Cl. CPC C11D 1/22; C11D 11/0017; C11D 11/0082; C11D 17/06

(57) ABSTRACT

The present invention relates to a process for making a magnesium linear alkyl benzene sulphonate anionic detersive surfactant flake.

### FIELD OF THE INVENTION

The present invention provides a process for making a magnesium linear alkyl benzene sulphonate anionic detersive surfactant flake. The flakes obtained by the process provide good cleaning performance, have good physical characteristics, and have a good colour profile in that they are white. The flakes obtained by the process are suitable for incorporation into a laundry detergent product.

### BACKGROUND OF THE INVENTION

Laundry detergent manufacturers formulate products with surfactants as the core chemistry to provide fabric cleaning during washing. One such surfactant category comprises anionic linear alkylbenzene sulphonates (LAS), which can be delivered in a number of physical forms. For the manufacture of solid powder detergents, these forms typically comprise a spray-dried particle, an agglomerated particle, or a flaked particle. Which of these forms is used typically depends on factors such as but not limited to the surfactant activity of the particle, the cost to manufacture the particle, the rate at which the particle can be produced, the physical properties of the particle, and/or any combination of these and/or other factors.

LAS flakes are typically the particles that carry highest LAS activity of the forms mentioned. The flakes can be produced via a heated surface drying process. Such heated surface drying processes can include drum drying processes, belt conveyer dryers or agitated thin film dryers. Whilst production rates might be lower than spray-drying or agglomeration/fluid-bed-drying processes, heated surface drying methods are more suited to dry viscous, concentrated solutions, e.g., to enable higher active end products, due to the liquid being applied as a thin film on the heated surface. Typically, the LAS present in heated surface drying processes LAS flakes exists in its sodium salt form (Na-LAS).

The downside of high active (Na-)LAS particles is their propensity to become cohesive at relatively low relative humidity environments, due to their hygroscopic and hygrosensitive nature. This causes LAS flakes to become difficult to handle in bulk, or even when manufacturing, unless using a form of moisture control, which can present cost challenges, limit production/consumption rates, etc.

The inventors have found that when producing LAS flakes by drying a paste that has LAS with a very high proportion of magnesium LAS via drum drying, any adhesive make-up caused by the dried LAS flake on the knife that separates the dried flake from the drum after drying has been completely removed.

The inventors have also found that higher water activity can be tolerated when very high proportions of Mg LAS is present. Furthermore, the inventors found that the resulting Mg LAS flake appears much whiter compared to a Na-LAS flake.

The Mg LAS flake has good physical characteristics, results in dissolved LAS able to partake in emulsification of grease, and has a good colour profile, i.e., a white appearance.

### SUMMARY OF THE INVENTION

The present invention provides a process for making a magnesium linear alkyl benzene sulphonate anionic detersive surfactant flake, wherein the process comprises the steps of:
(a) obtaining a magnesium linear alkyl benzene sulphonate anionic detersive surfactant liquid,
   wherein the liquid comprises from 30 wt % to 90 wt % solid material and from 10 wt % to 70 wt % water,
   wherein the solid material comprises from greater than 50 wt % to 100 wt % linear alkyl benzene sulphonate anionic detersive surfactant,
   and wherein the linear alkyl benzene sulphonate anionic detersive surfactant comprises from 70 wt % to 100 wt % magnesium linear alkyl benzene sulphonate anionic detersive surfactant;
(b) contacting the liquid to a heatable surface;
(c) drying the contacted liquid on the heatable surface; and
(d) removing the dried contacted liquid from the heatable surface to form the magnesium linear alkyl benzene sulphonate anionic detersive surfactant flake,
   wherein the magnesium linear alkyl benzene sulphonate anionic detersive surfactant flake comprises from greater than 50 wt % to 100 wt % linear alkyl benzene sulphonate anionic detersive surfactant,
   and wherein the linear alkyl benzene sulphonate anionic detersive surfactant comprises from 70 wt % to 100 wt % magnesium linear alkyl benzene sulphonate anionic detersive surfactant.

### DETAILED DESCRIPTION OF THE INVENTION

### Process for Making a Magnesium Linear Alkyl Benzene Sulphonate Anionic Detersive Surfactant Flake

The process for making a magnesium linear alkyl benzene sulphonate anionic detersive surfactant flake comprises the steps of:
(a) obtaining a magnesium linear alkyl benzene sulphonate anionic detersive surfactant liquid,
   wherein the liquid comprises from 30 wt % to 90 wt % solid material and from 10 wt % to 70 wt % water,
   wherein the solid material comprises from greater than 50 wt % to 100 wt % linear alkyl benzene sulphonate anionic detersive surfactant,
   and wherein the linear alkyl benzene sulphonate anionic detersive surfactant comprises from 70 wt % to 100 wt % magnesium linear alkyl benzene sulphonate anionic detersive surfactant;
(b) contacting the liquid to a heatable surface;
(c) drying the contacted liquid on the heatable surface; and
(d) removing the dried contacted liquid from the heatable surface to form the magnesium linear alkyl benzene sulphonate anionic detersive surfactant flake, wherein the magnesium linear alkyl benzene sulphonate anionic detersive surfactant flake comprises from greater than 50 wt % to 100 wt % linear alkyl benzene sulphonate anionic detersive surfactant,
   and wherein the linear alkyl benzene sulphonate anionic detersive surfactant comprises from 70 wt % to 100 wt % magnesium linear alkyl benzene sulphonate anionic detersive surfactant.

### Step (a) Obtaining a Magnesium Linear Alkyl Benzene Sulphonate Anionic Detersive Surfactant Liquid

Step (a) obtains a magnesium linear alkyl benzene sulphonate anionic detersive surfactant liquid.

Preferably, during step (a) the magnesium linear alkyl benzene sulphonate anionic detersive surfactant is obtained by reacting linear alkyl benzene sulphonic acid with a magnesium alkaline salt.

Preferably, during step (a) the reaction of linear alkyl benzene sulphonic acid with a magnesium alkaline salt occurs in the presence of water.

Preferably, during step (a) the magnesium alkaline salt is selected from a list that comprises magnesium hydroxide, magnesium carbonate, magnesium hydroxide carbonate, magnesium bicarbonate, and magnesium oxide.

### Step (b) Contacting the Liquid to a Heatable Surface

Step (b) contacts the liquid to a heatable surface.

Preferably, the heatable surface is heated when the liquid is contacted to the heatable surface. Alternatively, the heatable surface is not heated when the liquid is first contacted to the heatable surface, but is heated thereafter.

Where the heatable surface is heated when the liquid is contacted to the heatable surface, the heatable surface may have a surface temperature range of from 50° C. to 200° C., preferably between 100° C. to 200° C.

The heatable surface can be a rotatable heatable surface, or a non-rotatable heatable surface. If the heatable surface is a rotatable heatable surface, the rotational velocity of the heatable surface can range from 2 RPM to 60 RPM. The heatable surface may be continuously rotating throughout the process of may be intermittently rotating.

Preferably, if the heatable surface is a rotatable heatable surface, the heatable surface is rotating as the liquid is contacted to the heatable surface. Alternatively, the heatable surface is not rotating as the liquid is contacted to the heatable surface.

The heatable surface can be a concave or a convex heatable surface. If the heatable surface is a convex heatable surface, the outer diameter of the heatable surface can range from 0.4 m to 5.0 m.

The liquid can be contacted to the heatable surface by spraying the liquid as droplets onto the heatable surface by use of an atomizing nozzle. Alternatively, the liquid can be injected or pumped onto the heatable surface without forming liquid droplets.

The liquid can be contacted to the heatable surface by fully or partially submerging the heatable surface into a container which contains the liquid.

Preferably, after contacting the liquid to the heatable surface, the liquid is spread across the heatable surface to a uniform layer thickness by passing the contacted liquid through a gap that is formed by placing the heatable surface in close proximity to a spreading implement.

Alternatively, the contacted liquid spreads itself onto the heatable surface through gravitational forces that apply on the contacted liquid, without passing the contacted liquid through a gap.

If a spreading implement is used, more than one spreading implements can be used. The spreading implement or spreading implements can be located across the full surface of the heatable surface. Alternatively, the spreading implement or spreading implements can be located across a section of the heatable surface. The spreading implement can be a second heatable surface. Other suitable spreading implements include rollers and/or knives. The spreading implement can be a rotatable spreading implement, or a non-rotatable spreading implement. If the spreading implement is a rotating spreading implement, the rotational velocity of the spreading implement can range from 2 RPM to 600 RPM.

Preferably, the liquid layer thickness is between 100 μm and 1200 μm.

### Step (c) Drying the Contacted Liquid on the Heatable Surface

Step (c) dries the contacted liquid on the heatable surface.

Preferably, the liquid has a temperature in the range of from 20° C. to 90° C. when it is contacted to the heatable surface.

Preferably, the heatable surface is heated when the liquid is contacted to the heatable surface, and remains heated when the liquid is in contact with the heatable surface to dry the contacted liquid. Alternatively, the heatable surface is not heated when the liquid is contacted to and remains in contact with the heatable surface. Irrespective of whether the heatable surface is heated or not heated when the liquid is in contact with the heatable surface, the air in contact with the liquid can be heated to dry the contacted liquid.

The heatable surface can be heated by use of a hot fluid which indirectly heats the liquid in contact with the heatable surface, For example, the heatable surface may have a first side and a second side. The hot fluid may heat a first side and the second side may be in contact with the liquid to be dried. The hot fluid can be air, (pressurized) steam, an inorganic liquid, or an organic liquid. A preferred inorganic liquid is water.

When drying the contacted liquid, the temperature of the heatable surface can range from 50° C. to 200° C., preferably between 100° C. to 200° ° C. The temperature may be in the range of 70° C. to 190° C. Alternatively, the temperature may be in the range of 80° C. to 180° C. Alternatively, the temperature may be in the range of 90° C. to 170° C.

When drying the contacted liquid, the air pressure can be at atmospheric pressure. Alternative, the air pressure can be below atmospheric pressure.

The residence time of the contacted liquid on the heatable surface can range from 1 second to 60 minutes.

Step (d) Removing the Dried Contacted Liquid from the Heatable Surface

Step (d) removes the dried contacted liquid from the heatable surface to form the magnesium linear alkyl benzene sulphonate anionic detersive surfactant flake.

During step (d), the dried contacted liquid can be removed from the heated surface with a knife or scraper. Alternatively, the dried contacted liquid can be removed by the spreading implement or spreading implements as described in step (c).

Optionally, after step (d), the flake can be reprocessed by a size classification step to obtain a different granulometry. Preferably, the size classification step comprises a grinding and/or sieving step. Optionally, the size classification step additionally comprises an extrusion step.

After step (d), the flake can be cooled, for example to ambient temperature.

Preferably, the flake is incorporated into a laundry detergent composition.

### Magnesium Linear Alkyl Benzene Sulphonate Anionic Detersive Surfactant Liquid

The magnesium linear alkyl benzene sulphonate anionic detersive surfactant liquid comprises from 30 wt % to 90 wt % solid material and from 10 wt % to 70 wt % water.

Preferably, the liquid comprises from 50 wt % to 70 wt % solid material and from 30 wt % to 50 wt % water.

Preferably, the liquid has a viscosity of from 0.001 Pa·s to 100 Pa·s when measured at a shear rate of 1 reciprocal second.

### Solid Material

The solid material comprises from greater than 50 wt % to 100 wt % linear alkyl benzene sulphonate anionic detersive surfactant.

Preferably, the solid material comprises from greater than 70 wt % to 100 wt %, or from 80 wt % to 99 wt %, or from 80 wt % to 95 wt % linear alkyl benzene sulphonate anionic detersive surfactant.

Preferably, the solid material comprises carboxylic acid, carboxylate polymers, soil release polymers, PEG polymers, carbohydrate polymers, chelants, brighteners, sulphate salts, chloride salts, carbonate salts, silicate salts, magnesium salts, zeolite, and any combination thereof.

### Linear Alkyl Benzene Sulphonate Anionic Detersive Surfactant

The linear alkyl benzene sulphonate anionic detersive surfactant comprises from 70 wt % to 100 wt %, or from 80 wt % to 99 wt %, or from 80 wt % to 95 wt % magnesium linear alkyl benzene sulphonate anionic detersive surfactant.

Preferably, the linear alkyl benzene sulphonate anionic detersive surfactant comprises from 80 wt % to 100 wt %, or from 80 wt % to 99 wt %, or from 80 wt % to 95 wt % magnesium linear alkyl benzene sulphonate anionic detersive surfactant.

### Magnesium Linear Alkyl Benzene Sulphonate Anionic Detersive Surfactant Flake

The magnesium linear alkyl benzene sulphonate anionic detersive surfactant flake comprises from greater than 50 wt % to 100 wt %, or from 60 wt % to 99 wt %, or from 70 wt % to 95 wt %, or from 80 wt % to 90 wt % linear alkyl benzene sulphonate anionic detersive surfactant.

Preferably, the flake is anhydrous or has a moisture content of from above 0 wt % to 10 wt % water.

The flake may comprise other ingredients, such as detergent ingredients, in addition to the linear alkyl benzene sulphonate anionic detersive surfactant.

Preferably, the alkyl benzene sulphonate anionic detersive surfactant flake comprises from greater than 70 wt % to 100 wt % linear alkyl benzene sulphonate anionic detersive surfactant, and wherein the linear alkyl benzene sulphonate anionic detersive surfactant comprises from 80 wt % to 100 wt % magnesium linear alkyl benzene sulphonate anionic detersive surfactant.

Preferably, the thickness of the flake is from 100 μm to 1200 μm.

Preferably, the particle size distribution of the flake is such that at least 90 wt % of the flakes have a particle width of less than 2000 μm, at least 90 wt % of the flakes have a particle length of less than 2000 μm, and at least 90 wt % of the flakes have a particle height or thickness of less than 2000 μm.

Preferably, the particle size distribution of the flake is such that at least 90 wt % of the flakes have a particle width of more than 50 μm, at least 90 wt % of the flakes have a particle length of more than 50 μm, and at least 90 wt % of the flakes have a particle height or thickness of more than 50 μm.

Preferably, the flake has an aspect ratio of from 1 to 20 to from 1 to 20 to from 1 to 20 of its length to its width to its height or thickness respectively.

### Heatable Surface

Any suitable heatable surface can be used as described above.

A preferred heatable surface is the external surface of a drum dryer (DD). Alternatively, the heatable surface is the internal surface of an agitated thin film dryer (ATFD). Alternatively, the heatable surface is the external surface of a belt conveyor dryer (BCD). The person skilled in the art will be familiar with such apparatuses.

If a DD is used to dry the magnesium linear alkyl benzene sulphonate anionic detersive surfactant liquid into a magnesium linear alkyl benzene sulphonate anionic detersive surfactant flake then preferably, the heatable surface is heated when the liquid is contacted to the heatable surface, and remains heated when the liquid is in contact with the heatable surface. Preferably, the heatable surface is a rotating heatable surface. Preferably, the rotating heatable surface has a rotational velocity of 2 RPM to 60 RPM. Preferably, the heatable surface is a convex external heatable surface. Preferably, the heatable surface has a diameter of 0.4 m to 5.0 m. Preferably, the liquid is contacted to the heatable surface by spraying the liquid as droplets onto the heatable surface by use of an atomizing nozzle; alternatively, the liquid is injected or pumped onto the heatable surface without the forming liquid droplets; alternatively, the liquid is be contacted to the heatable surface by (partially) submerging the heatable surface into a container which contains the liquid. Preferably, the liquid is spread across the heatable surface to a uniform layer thickness by passing the contacted liquid through a gap that is formed by placing the heatable surface in close proximity to a spreading implement. Preferably, one or more spreading implements is used, located across a section of the heatable surface. Preferably, the spreading implement is a second rotatable heatable surface; preferably the second rotable heatable surface has a rotational velocity of 2 RPM to 60 RPM. Preferably, the layer thickness of the contacted liquid is between 100 μm and 1200 μm. Preferably, the liquid has a temperature in the range of from 20° C. to 90° C. when it is contacted to the heatable surface. Preferably, the heatable surface is heated by passing (pressurized) steam through the inner surface of the heatable surface, which is not in contact with the contacted liquid. Preferably, the heatable surface has a surface temperature range of from 50° C. to 200° C. Preferably, the residence time of the contacted liquid on the heatable surface ranges from 1 second to 30 minutes. Preferably, the dried contacted liquid is removed from the heatable surface with a knife or scraper to form a flake. Preferably, the flake is reprocessed by a size classification comprising a grinding and/or sieving step. Preferably, the flake is cooled to ambient temperature. Preferably, the flake is incorporated into a laundry detergent composition.

If an ATFD is used to dry the magnesium linear alkyl benzene sulphonate anionic detersive surfactant liquid into a magnesium linear alkyl benzene sulphonate anionic detersive surfactant flake, then preferably, the heatable surface is heated when the liquid is contacted to the heatable surface. Preferably, the heatable surface is a non-rotating heatable surface. Preferably, the heatable surface is a concave internal heatable surface. Preferably, the liquid is contacted to the heatable surface by dosing the liquid onto a rotating distributor plate, the surface of which is perpendicular to the heatable surface, which applies a centrifugal force to the liquid to contact it to the heatable surface. Preferably, the liquid is spread across the heatable surface to a uniform layer thickness by passing the contacted liquid through a gap that is formed by placing the heatable surface in close proximity to a spreading implement. Preferably, one spreading implement is used, located across the full surface of the heatable surface. Preferably, the spreading implement rotatable surface; preferably the spreading implement has a rotational velocity of 60 RPM to 600 RPM. Preferably, the layer thickness is between 100 μm and 1200 μm. Preferably, the liquid has a temperature in the range of from 20° C. to 90° C. when it is contacted to the heatable surface. Preferably, the heatable surface is heated by passing (pressurized) steam, or an inorganic liquid, or an organic liquid through a heat jacket that surrounds the heatable surface, which is not in contact with the contacted liquid. Preferably, the heatable surface has a surface temperature range of from 50° C. to 200° C. Preferably, the air pressure in contact with the contacted liquid is below atmospheric pressure. Preferably, the residence time of the contacted liquid on the heatable surface ranges from 1 second to 10 minutes. Preferably, the dried contacted liquid is removed from the heatable surface with the spreading implement used to spread the liquid across the heatable surface. Preferably, the flake is reprocessed by a size classification comprising a grinding and/or extrusion and/or sieving step. Preferably, the flake is cooled to ambient temperature. Preferably, the flake is incorporated into a laundry detergent composition.

If a BCD is used to dry the magnesium linear alkyl benzene sulphonate anionic detersive surfactant liquid into a magnesium linear alkyl benzene sulphonate anionic detersive surfactant flake, then preferably, the heatable surface is heated when the liquid is contacted to the heatable surface, and remains heated when the liquid is in contact with the heatable surface. Preferably, the heatable surface is a rotating heatable surface. Preferably, the rotating heatable surface has a rotational velocity of 2 RPM to 60 RPM. Preferably, the heatable surface is a convex external heatable surface. Preferably, the liquid is contacted to the heatable surface by spraying the liquid as droplets onto the heatable surface by use of an atomizing nozzle; alternatively, the liquid is injected or pumped onto the heatable surface without the forming liquid droplets. Preferably, the liquid is spread across the heatable surface to a uniform layer thickness by passing the contacted liquid through a gap that is formed by placing the heatable surface in close proximity to a spreading implement. Preferably, one or more spreading implements is used, located across a section of the heatable surface. Preferably, the layer thickness of the contacted liquid is between 100 μm and 1200 μm. Preferably, the liquid has a temperature in the range of from 20° C. to 90° C. when it is contacted to the heatable surface. Preferably, the heatable surface is heated by passing (pressurized) steam through the inner surface of the heatable surface, which is not in contact with the contacted liquid, and/or the air in contact with the liquid is heated. Preferably, the heatable surface has a surface temperature range of from 50° C. to 200° C.; if air is used to heat the contacted liquid, preferably, the air has a temperature of 50° C. to 100° C. Preferably, the residence time of the contacted liquid on the heatable surface ranges from 5 minutes to 60 minutes. Preferably, the dried contacted liquid is removed from the heatable surface with a knife or scraper to form a flake. Preferably, the flake is reprocessed by a size classification comprising a grinding and/or sieving step. Preferably, the flake is cooled to ambient temperature. Preferably, the flake is incorporated into a laundry detergent composition.

### Embodiments of the Present Invention

A. A process for making a magnesium linear alkyl benzene sulphonate anionic detersive surfactant flake, wherein the process comprises the steps of:
(a) obtaining a magnesium linear alkyl benzene sulphonate anionic detersive surfactant liquid,
wherein the liquid comprises from 30 wt % to 90 wt % solid material and from 10 wt % to 70 wt % water,
wherein the solid material comprises from greater than 50 wt % to 100 wt % linear alkyl benzene sulphonate anionic detersive surfactant,
and wherein the linear alkyl benzene sulphonate anionic detersive surfactant comprises from 70 wt % to 100 wt % magnesium linear alkyl benzene sulphonate anionic detersive surfactant;
(b) contacting the liquid to a heated surface;
(c) rotating the heated drum dryer and drying the contacted liquid on the rotating heated drum dryer; and
(d) removing the dried contacted liquid from the rotating heated drum dryer to form the magnesium linear alkyl benzene sulphonate anionic detersive surfactant flake,
wherein the magnesium linear alkyl benzene sulphonate anionic detersive surfactant flake comprises from greater than 50 wt % to 100 wt % linear alkyl benzene sulphonate anionic detersive surfactant,
and wherein the linear alkyl benzene sulphonate anionic detersive surfactant comprises from 70 wt % to 100 wt % magnesium linear alkyl benzene sulphonate anionic detersive surfactant.
B. A process according to paragraph A, wherein the liquid comprises from 50 wt % to 70 wt % solid material and from 30 wt % to 50 wt % water,
wherein the solid material comprises from greater than 70 wt % to 100 wt % linear alkyl benzene sulphonate anionic detersive surfactant,
and wherein the linear alkyl benzene sulphonate anionic detersive surfactant comprises from 80 wt % to 100 wt % magnesium linear alkyl benzene sulphonate anionic detersive surfactant.
C. A process according to any of paragraphs A or B, wherein the liquid has a viscosity of from 0.001 Pa·s to 100 Pa·s when measured at a shear rate of 1 reciprocal second.
D. A process according to any of paragraphs A-C, wherein the solid material comprises carboxylic acid, carboxylate polymers, soil release polymers, PEG polymers, carbohydrate polymers, chelants, brighteners, sulphate salts, chloride salts, carbonate salts, silicate salts, magnesium salts, zeolite, and any combination thereof.
E. A process according to any of paragraphs A-D, wherein during step (b) the heated surface is rotating when the liquid is contacted to it.
F. A process according to any of paragraphs A-E, wherein during step (b) the liquid has a temperature in the range of from 20° C. to 90° C. when it is contacted to the heated surface.
G. A process according to any of paragraphs A-F, wherein during step (c) the heated surface has a temperature in the range of from 100° C. to 200° C.
H. A process according to any of paragraphs A-G, wherein during step (c) the contacted liquid is spread onto the rotating drum by passing the contacted liquid through a gap that is formed by placing the heated surface in close proximity to a spreading implement such that the gap distance between the heated surface and the spreading implement is in range of from 100 μm to 1200 μm.
I. A process according to paragraph H, wherein the spreading implement is a second heated surface.
J. A process according to any of paragraphs I, wherein flake is anhydrous or has a moisture content of from above 0 wt % to 10 wt % water.
K. A process according to paragraphs A-J, wherein after removal from the heated surface, the dried contacted liquid is subjected to a size classification step, and wherein the flake formed has a d50 particle width in the range of from 100 μm to 1200 μm, a d50 particle length in the range of from 100 μm to 1200 μm, and a d50 particle height or thickness in the range of from 100 μm to 1200 μm.
L. A magnesium linear alkyl benzene sulphonate anionic detersive surfactant flake obtained by a process according to any preceding paragraph A-K.
13. A laundry detergent composition comprising a flake according to paragraph L.

### EXAMPLES

In the examples outlined below, experiments were ran on a drum dryer as the heatable surface.

### Example 1

Two pastes were made as liquid feed for the drum drying process with objective to produce a dried LAS flake.

| | Invention - Paste A | Paste B |
|---|---|---|
| MgLAS₂ [% w] | 61.8 | |
| NaLAS [% w] | | 61.5 |
| Polycarboxylate [% w] | 1.0 | 1.0 |
| Sodium sulphate [% w] | 4.5 | 4.5 |
| Moisture content [% w] | 32.7 | 32.8 |

Both flakes were separately dried on a drum dryer. The temperature at the outside of the drum was measured at 160±10° C. The outer diameter of the drum was measured at 127 mm. The rotational velocity of the drum was set to 1.3 revolutions per minute. The gap clearance to the drum was set to 381 μm. Approximately 7 grams of paste was applied to the drum from the top to create a discrete area of paste on the drum with a distance between the two ends of the area of paste, where the drum was not covered by paste. Whilst the paste was drying, the scraper was removed and replaced on the area of the drum that was not covered by the paste after 5 minutes of drying.

Using these settings, when Paste B touched the knife in an attempt to remove the dried paste/flake from the drum, material was observed to accumulate on the knife in rolling fashion as the full paste slab was removed. The rolled-up accumulation had to be manually removed from the knife. The rolled-up accumulation showed signs of darkening of the originally white feed material into a yellow/brown hue.

Using these settings, when Paste A touched the knife in an attempt to remove the dried paste/flake from the drum, material was observed to crumble off the knife without the need for manual removal of any matter. The resulting material was flake-like in nature, and white in appearance.

### Example 2

Two pastes were made as liquid feed for the drum drying process with objective to produce a dried LAS flake.

| | Invention - Paste A | Paste B |
|---|---|---|
| MgLAS₂ [% w] | 56.4 | |
| NaLAS [% w] | 5.4 | 58.0 |
| Trisodium sulphosuccinate [% w] | | 1.4 |
| Sulphosuccinic acid [% w] | 1.0 | |
| Sodium sulphate [% w] | 4.1 | 4.1 |
| Moisture content [% w] | 32.5 | 36.7 |

Both flakes were separately dried on a drum dryer. The temperature at the outside of the drum was measured at 160±10° C. The outer diameter of the drum was measured at 127 mm. The rotational velocity of the drum was set to 1.3 revolutions per minute. The gap clearance to the drum was set to 50 μm. Approximately 7 grams of paste was applied to the drum from the top to create a discrete area of paste on the drum with a distance between the two ends of the area of paste, where the drum was not covered by paste. The paste was dried and scraped off using a knife before the drum made a full revolution.

Using these settings, the equilibrium relative humidity (or water activity) of the flake resulting from the dried Paste B was measured to be 18%±2%. Using these settings, the equilibrium relative humidity (or water activity) of the flake resulting from the dried Paste B was measured to be 31%±2%. Both flakes were free-flowing in nature.

### Example 3

Eight pastes were made as liquid feed for the drum drying process with objective to produce a dried LAS flake.

| | Invention | Invention | Invention | Invention | Paste | Paste | Paste | Paste |
|---|---|---|---|---|---|---|---|---|
| | Paste A | Paste B | Paste C | Paste D | E | F | G | H |
| NaLAS [% w] | | 5.4 | 6.2 | 11.0 | 31.0 | 33.6 | 61.8 | 61.9 |
| Mg(LAS)₂ [% w] | 61.8 | 56.4 | 55.6 | 50.8 | 30.9 | 28.2 | | |
| Polycarboxylate | 1.0 | | 1.0 | | 1.0 | | | 1.0 |
| [% w] | | | | | | | | |
| Trisodium | | | | 0.1 | | 0.7 | 1.4 | |
| sulphosuccinate | | | | | | | | |
| [% w] | | | | | | | | |
| Sulphosuccinic | | 1.0 | | 0.9 | | 0.5 | | |
| acid [% w] | | | | | | | | |
| Sodium sulphate | 4.5 | 4.1 | 4.5 | 4.1 | 4.5 | 4.1 | 4.1 | 4.5 |
| [% w] | | | | | | | | |
| Moisture content | 32.8 | 32.5 | 32.8 | 32.5 | 32.7 | 32.6 | 32.7 | 32.6 |
| [% w] | | | | | | | | |
| NaLAS [% w of | 0 | 9 | 10 | 18 | 50 | 54 | 100 | 100 |
| total LAS] | | | | | | | | |
| MgLAS₂ [% w of | 100 | 91 | 90 | 82 | 50 | 46 | 0 | 0 |
| total LAS] | | | | | | | | |
| Dried mass | Yes | Yes | Yes | Yes | No | No | No | No |
| crumbles off the | | | | | | | | |
| knife without | | | | | | | | |
| need for manually | | | | | | | | |
| removing | | | | | | | | |
| accumulated dried | | | | | | | | |
| mass off the knife | | | | | | | | |

All flakes were separately dried on a drum dryer. The temperature at the outside of the drum was measured at 160±10° C. The outer diameter of the drum was measured at 127 mm. The rotational velocity of the drum was set to 1.3 revolutions per minute. The gap clearance to the drum was set to 381 μm. Approximately 7 grams of paste was applied to the drum from the top to create a discrete area of paste on the drum with a distance between the two ends of the area of paste, where the drum was not covered by paste. Whilst the paste was drying, the scraper was removed and replaced on the area of the drum that was not covered by the paste after 5 minutes of drying.

Using these settings, Pastes A, B, C, and D were observed to come off the scraper in crumbling fashion without the need for manual intervention to remove the dried mass from the scraper. Using these settings, Pastes E, F, G, and H were observed to accumulate on the knife, the accumulated dried mass needing manual intervention to be removed from the scraper.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a magnesium linear alkyl benzene sulphonate anionic detersive surfactant flake, wherein the process comprises the steps of:
(a) obtaining a magnesium linear alkyl benzene sulphonate anionic detersive surfactant liquid,
wherein the liquid comprises from about 30 wt % to about 90 wt % solid material and from about 10 wt % to about 70 wt % water,
wherein the solid material comprises from greater than about 50 wt % to about 100 wt % linear alkyl benzene sulphonate anionic detersive surfactant,
and wherein the linear alkyl benzene sulphonate anionic detersive surfactant comprises from about 70 wt % to about 100 wt % magnesium linear alkyl benzene sulphonate anionic detersive surfactant;
(b) contacting the liquid to a heatable surface;
(c) drying the contacted liquid on the heatable surface; and
(d) removing the dried contacted liquid from the heatable surface to form the magnesium linear alkyl benzene sulphonate anionic detersive surfactant flake, wherein the magnesium linear alkyl benzene sulphonate anionic detersive surfactant flake comprises from greater than about 50 wt % to about 100 wt % linear alkyl benzene sulphonate anionic detersive surfactant, and wherein the linear alkyl benzene sulphonate anionic detersive surfactant comprises from about 70 wt % to about 100 wt % magnesium linear alkyl benzene sulphonate anionic detersive surfactant.

2. The process according to claim 1, wherein the liquid comprises from about 50 wt % to about 70 wt % solid material and from about 30 wt % to about 50 wt % water, wherein the solid material comprises from greater than about 70 wt % to about 100 wt % linear alkyl benzene sulphonate anionic detersive surfactant, and wherein the linear alkyl benzene sulphonate anionic detersive surfactant comprises from about 80 wt % to about 100 wt % magnesium linear alkyl benzene sulphonate anionic detersive surfactant.

3. The process according to claim 1, wherein the liquid has a viscosity of from about 0.001 Pa·s to about 100 Pa·s when measured at a shear rate of 1 reciprocal second.

4. The process according to claim 1, wherein the solid material comprises carboxylic acid, carboxylate polymers, soil release polymers, PEG polymers, carbohydrate polymers, chelants, brighteners, sulphate salts, chloride salts, carbonate salts, silicate salts, magnesium salts, zeolite, and any combination thereof.

5. The process according to claim 1, wherein the heatable surface is rotatable, wherein it may be continuously rotating throughout the process or may be intermittently rotating.

6. The process according to claim 5 wherein when the heatable surface is rotating it is doing so at a rotational velocity of from about 2 RPM to about 60 RPM.

7. The process according to claim 5, wherein during step (b) the heatable surface is rotating when the liquid is contacted to it, or wherein the heatable surface is not rotating when the liquid is contacted to it.

8. The process according to claim 1, wherein the heatable surface can be a concave or a convex heatable surface.

9. The process according to claim 8 wherein, the heatable surface is a convex heatable surface, and wherein the outer diameter of the heatable surface can range from about 0.4 m to about 5.0 m.

10. The process according to claim 1, wherein during step (b) the liquid has a temperature in the range of from about 20° C. to about 90° C. when it is contacted to the heatable surface.

11. The process according to claim 1, wherein during step (c) the heatable surface has a surface temperature in the range of from about 50° C. to about 200° C., alternatively, the temperature may be in the range of about 80° C. to about 180° C., alternatively, the temperature may be in the range of about 90° C. to about 170° C.

12. The process according to claim 1, wherein after contacting the liquid to the heatable surface, the liquid is spread across the heatable surface to a uniform layer thickness by passing the contacted liquid through a gap that is formed by placing the heatable surface in close proximity to a spreading implement, or alternatively, the contacted liquid spreads itself onto the heatable surface through gravitational forces that apply on the contacted liquid.

13. A process according to claim 12, wherein the spreading implement is a second heated surface.

14. The process according to claim 1, wherein the flake is anhydrous or has a moisture content of from above about 0 wt % to about 10 wt % water.

15. A process according to claim 1, wherein after removal from the heated surface, the dried contacted liquid is subjected to a size classification step, and wherein the flake formed has a d₅₀ particle width in the range of from about 100 μm to about 1200 μm, a d₅₀ particle length in the range of from about 100 μm to about 1200 μm, and a d₅₀ particle height or thickness in the range of from about 100 μm to about 1200 μm.

16. A magnesium linear alkyl benzene sulphonate anionic detersive surfactant flake obtained by a process according to claim 1.

17. A laundry detergent composition comprising a flake according to claim 16.
